(19) United States
(12) Patent Application Publication
(10) Pub. No.: US 2002/0128830 A1
(43) Pub. Date: Sep. 12, 2002

(54) Method and apparatus for suppressing noise components contained in speech signal

(76) Inventors: Hiroshi Kanazawa, Ebina-shi (JP); Masahiro Oshikiri, Yokosuka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/054,938

(22) Filed: Jan. 25, 2002

(30) Foreign Application Priority Data
Jan. 25, 2001 (JP) 2001-017072

(51) Int. Cl. G10L 21/02

(52) U.S. Cl. 704/226

(57) ABSTRACT

There is provided a method of suppressing noise components contained in an input speech signal. The method includes obtaining an input spectrum by executing frequency analysis of the input speech signal by a specific frame length, obtaining an estimated noise spectrum by estimating the spectrum of the noise components, obtaining the spectral slope of the estimated noise spectrum, multiplying the estimated noise spectrum by a spectral subtraction coefficient determined by the spectral slope, obtaining a subtraction spectrum by subtracting the estimated noise spectrum multiplied with the spectral subtraction coefficient from the input spectrum, and obtaining a speech spectrum by clipping the subtraction spectrum. The method may further include correcting the speech spectrum by smoothing in at least one of frequency and time domains. In this way, a speech spectrum in which noise components have been suppressed can be obtained.

### CROSS-REFERENCE TO RELATED APPLICATIONS

This application is based upon and claims the benefit of priority from the prior Japanese Patent Application No. 2001-017072, filed Jan. 25, 2001, the entire contents of which are incorporated herein by reference.

### BACKGROUND OF THE INVENTION

1. Field of the Invention

The present invention relates to a method and apparatus for suppressing noise components contained in a speech signal.

2. Description of the Related Art

In order to make speech easier to hear or to improve a speech recognition rate in a noise environment, a technique for suppressing noise components such as background noise and the like contained in a speech signal is used. Of conventional noise suppression techniques, as a method of obtaining an effect with relatively fewer computations, for example, a spectral subtraction method described in reference 1: S. F. Boll, “Suppression of acoustic noise in speech using spectral subtraction”, IEEE transactions on Acoustics, Speech and Signal processing, Vol. Assp-27, No. 2, April 1979, pp. 113-120, is known.

In the spectral subtraction method, an input speech signal undergoes frequency analysis to obtain the spectrum of the power or amplitude (to be referred to as an input spectrum hereinafter), an estimated noise spectrum which has been estimated in a noise period is multiplied by a specific coefficient (spectral subtraction coefficient) α, and the estimated noise spectrum multiplied by the spectral subtraction coefficient α is subtracted from the input spectrum, thus suppressing noise components. In practice, when the spectrum after the estimated noise spectrum is subtracted from the input spectrum becomes smaller than zero or a specific value close to zero, clipping is made using that specific value as a clipping level, thereby finally obtaining an output speech signal, noise components of which have been suppressed.

The processes for suppressing noise by the spectral subtraction method will be explained below using FIGS. 1 and 2. FIG. 1 shows an input spectrum (solid line) obtained by executing frequency analysis of a voiced period of an input speech signal by a specific frame length, an estimated noise spectrum (dotted line), and an output spectrum (dashed curve) after the estimated noise spectrum is subtracted from the input spectrum, and clipping is then made. FIG. 2 shows the spectrum analysis result of the identical period of the input speech signal under a clean condition free from any superposed noise.

Let X(m) be the input spectrum, and N(m) be the estimated noise spectrum. Then, the output spectrum Y(m) is given by:

Y(m)=max(X(m)−αN(m), Tcl·X(m))

where max( ) is a function that outputs a maximum value, Tcl is a clipping coefficient, and m is an index corresponding to the frequency.

In another method, the spectral subtraction coefficient α is set to be a value larger than 1, and a value larger than the original estimated noise spectrum value is subtracted from the input spectrum. This method is generally called Over-subtraction, and is effective for speech recognition.

When noise is suppressed by the aforementioned spectral subtraction method, it is ideally demanded that the output spectrum Y(m) be approximate to the spectrum under the clean condition shown in FIG. 2. However, in practice, some spectral peaks remain at formants, and the remaining spectrum attenuates largely in the output spectrum Y(m), as shown in FIG. 1. Hence, formant shapes cannot be accurately expressed (first problem).

The first problem occurs as follows. If the relationship between the input spectrum X(m) and estimated noise spectrum N(m) meets the condition X(m)−αN(m)>Tcl·X(m), the output spectrum Y(m) is given by a value X(m)−αN(m) (arrow A in FIG. 1). If this condition is not met, a spectrum Tcl·X(m) multiplied by the clipping coefficient is output as the output spectrum Y(m). In order to obtain the spectral subtraction effect, the clipping coefficient Tcl must be set to be a value as very small as 0.01, thus posing the first problem.

On the other hand, a spectral peak may disappear from a position where it should remain, depending on the shape of the estimated noise spectrum (second problem). FIG. 3 shows the input spectrum when noise components having relatively large middle-range power are superposed on the input speech signal in the same period as that of FIG. 1. If the input spectrum and noise spectrum have such relationship, a spectral peak which should be present at the position of arrow B disappears. In case of FIG. 3, information indicating second formant F2 in FIG. 2 disappears. As a result, the speech recognition rate lowers.

In order to implement the effective spectral subtraction method, it is indispensable to accurately estimate a noise spectrum. In general, upon estimation of the noise spectrum, an unvoiced period of an input speech signal undergoes frequency analysis, and its average value is used as the estimated noise spectrum. However, it is very difficult to accurately determine the unvoiced period in a noise environment, and the estimated noise spectrum is often calculated using the spectrum of a voiced period.

At the beginning of a voiced period (word), a phoneme such as a consonant, the spectral characteristics of which shift to the high-frequency range, often appears, and the value of the estimated noise spectrum becomes larger an actual noise spectrum with increasing frequency. For this reason, the estimated noise spectrum is excessively subtracted from the input spectrum, thus disturbing correct noise suppression (third problem).

FIGS. 4 and 5 show a case wherein unvoiced period determination has failed, and the noise spectrum is estimated using the spectrum of a consonant. FIG. 4 shows a case wherein an original noise spectrum has a large amplitude in the high-frequency range, and FIG. 5 shows a case wherein an original noise spectrum has a small amplitude in the high-frequency range. As can be seen from comparison between FIGS. 4 and 5, the influences on the estimated noise spectrum vary depending on the shapes of the noise spectrum, and become more serious with decreasing high-frequency amplitude of the noise spectrum. That is, with decreasing high-frequency amplitude of the estimated noise spectrum, the estimation errors of the noise spectrum become larger, and the tendency of excessive subtraction of the estimated noise spectrum from the input spectrum becomes stronger.

The aforementioned three problems are mainly posed when the estimated noise spectrum has low reliability, when the characteristics of the noise spectrum have varied, when the phase of the complex spectrum of a speech signal is largely different from that of the complex spectrum of noise components, and so forth, resulting in a low speech recognition rate.

As described above, since the conventional noise suppression technique suffers the problems: (1) the output speech spectrum cannot accurately express the formant shapes of the input speech signal; (2) a spectral peak of a portion where it should remain disappears depending on the shape of the estimated noise spectrum; and (3) the estimated noise spectrum is excessively subtracted from the input spectrum due to estimation errors of the noise spectrum, adequate noise suppression cannot be implemented. Also, when such technique is used in a pre-process of speech recognition, it is not so effective to improve the recognition rate.

### BRIEF SUMMARY OF THE INVENTION

It is an object of the present invention to provide a method and apparatus for suppressing noise components contained in an input speech signal without impairing the spectrum of the speech signal.

According to one aspect of the present invention, there is provided a method of suppressing noise components contained in an input speech signal, comprising: obtaining an input spectrum by executing frequency analysis of the input speech signal by a specific frame length; obtaining an estimated noise spectrum by estimating a spectrum of the noise components; multiplying the estimated noise spectrum by a specific spectral subtraction coefficient; obtaining a subtraction spectrum by subtracting the estimated noise spectrum multiplied with the spectral subtraction coefficient from the input spectrum; obtaining a speech spectrum by clipping the subtraction spectrum; and correcting the speech spectrum by smoothing in at least one of frequency and time domains.

According to another aspect of the present invention, there is provided a method of suppressing noise components contained in an input speech signal, comprising: obtaining an input spectrum by executing frequency analysis of the input speech signal by a specific frame length; obtaining an estimated noise spectrum by estimating a spectrum of the noise components; obtaining a spectral slope of the estimated noise spectrum; multiplying the estimated noise spectrum by a spectral subtraction coefficient determined by the spectral slope; obtaining a subtraction spectrum by subtracting the estimated noise spectrum multiplied with the spectral subtraction coefficient from the input spectrum; and obtaining a speech spectrum by clipping the subtraction spectrum.

According to still another aspect of the present invention, there is provided a noise suppression apparatus for suppressing noise components contained in an input speech signal, comprising: a frequency analyzer configured to obtain an input spectrum by executing frequency analysis of the input speech signal by a specific frame length; a noise spectrum estimation unit configured to obtain an estimated noise spectrum by estimating a spectrum of the noise components; a multiplier configured to multiply the estimated noise spectrum by a specific spectral subtraction coefficient; a subtractor configured to obtain a subtraction spectrum by subtracting the estimated noise spectrum multiplied with the spectral subtraction coefficient from the input spectrum; a clipping unit configured to obtain a speech spectrum by clipping the subtraction spectrum; and a spectrum correction unit configured to correct the speech spectrum by smoothing in at least one of frequency and time domains.

According to yet another aspect of the present invention, there is provided a noise suppression apparatus for suppressing noise components contained in an input speech signal, comprising: a frequency analyzer configured to obtain an input spectrum by executing frequency analysis of the input speech signal by a specific frame length; a noise spectrum estimation unit configured to obtain an estimated noise spectrum by estimating a spectrum of the noise components; a spectral slope calculation unit configured to obtain a spectral slope of the estimated noise spectrum; a multiplier configured to multiply the estimated noise spectrum by a spectral subtraction coefficient determined by the spectral slope; a subtractor configured to obtain a subtraction spectrum by subtracting the estimated noise spectrum multiplied with the spectral subtraction coefficient from the input spectrum; and a clipping unit configured to obtain a speech spectrum by clipping the subtraction spectrum.

### BRIEF DESCRIPTION OF THE SEVERAL VIEWS OF THE DRAWING

FIG. 1 shows an example of an input spectrum, estimated noise spectrum, and output spectrum to explain the first problem of the spectral subtraction method;

FIG. 2 shows an output spectrum obtained by the spectral subtraction method under a clean condition;

FIG. 3 shows an example of an input spectrum, estimated noise spectrum, and output spectrum to explain the second problem of the spectral subtraction method;

FIG. 4 shows an original noise spectrum with a large high-frequency amplitude, and an estimated noise spectrum to explain the third problem of the spectral subtraction method;

FIG. 5 shows an original noise spectrum with a small high-frequency amplitude, and an estimated noise spectrum to explain the third problem of the spectral subtraction method;

FIG. 6 is a block diagram showing the arrangement of a noise suppression apparatus according to a first embodiment of the present invention;

FIG. 7 is a flow chart showing the flow of a noise suppression process in the first embodiment;

FIG. 8 shows spectra before and after correction when a speech spectrum is smoothed (corrected) in the frequency domain in the first embodiment, and a spectrum under the clean condition;

FIG. 9 shows spectra before and after correction when a speech spectrum is corrected by convolution using a specific function in the first embodiment, and a spectrum under the clean condition;

FIG. 10 shows spectra before and after correction when a speech spectrum is smoothed (corrected) in the time domain in the first embodiment;

FIG. 11 is a block diagram showing the arrangement of a noise suppression apparatus according to a second embodiment of the present invention;

FIG. 12 is a flow chart showing the flow of a noise suppression process in the second embodiment;

FIG. 13 is a block diagram showing the arrangement of a noise suppression apparatus according to a third embodiment of the present invention;

FIG. 14 is a flow chart showing the flow of a noise suppression process in the third embodiment; and

FIG. 15 is a block diagram showing the arrangement of a speech recognition apparatus according to a fourth embodiment of the present invention.

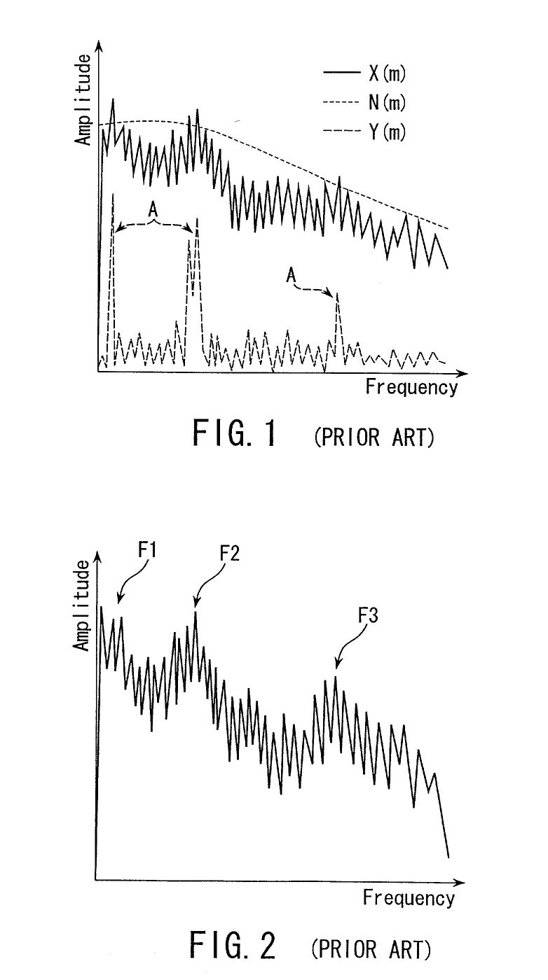

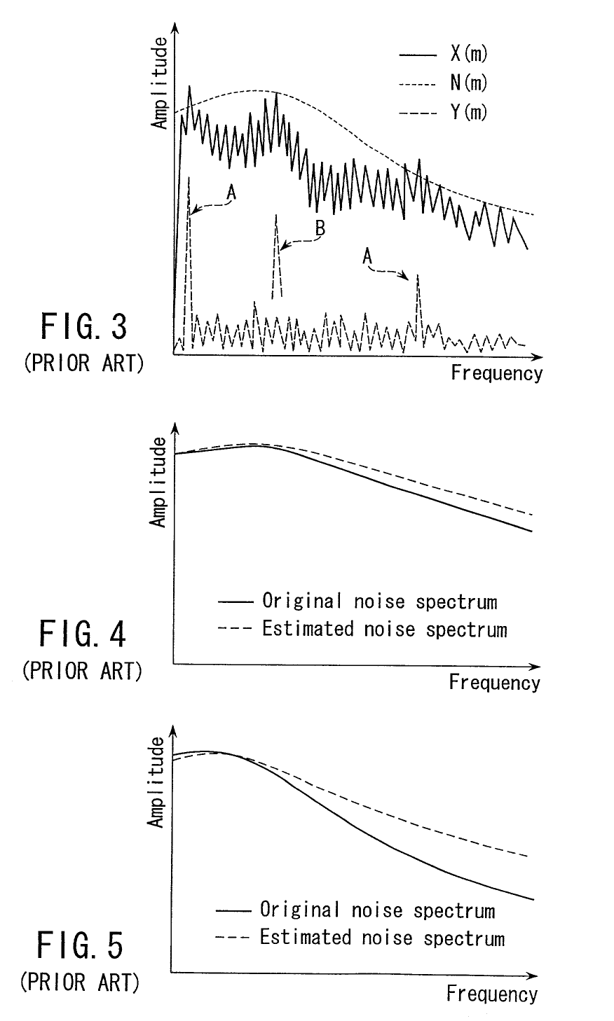

### DETAILED DESCRIPTION OF THE INVENTION

Embodiments of the present invention will be described hereinafter with reference to the accompanying drawings.

<First Embodiment>

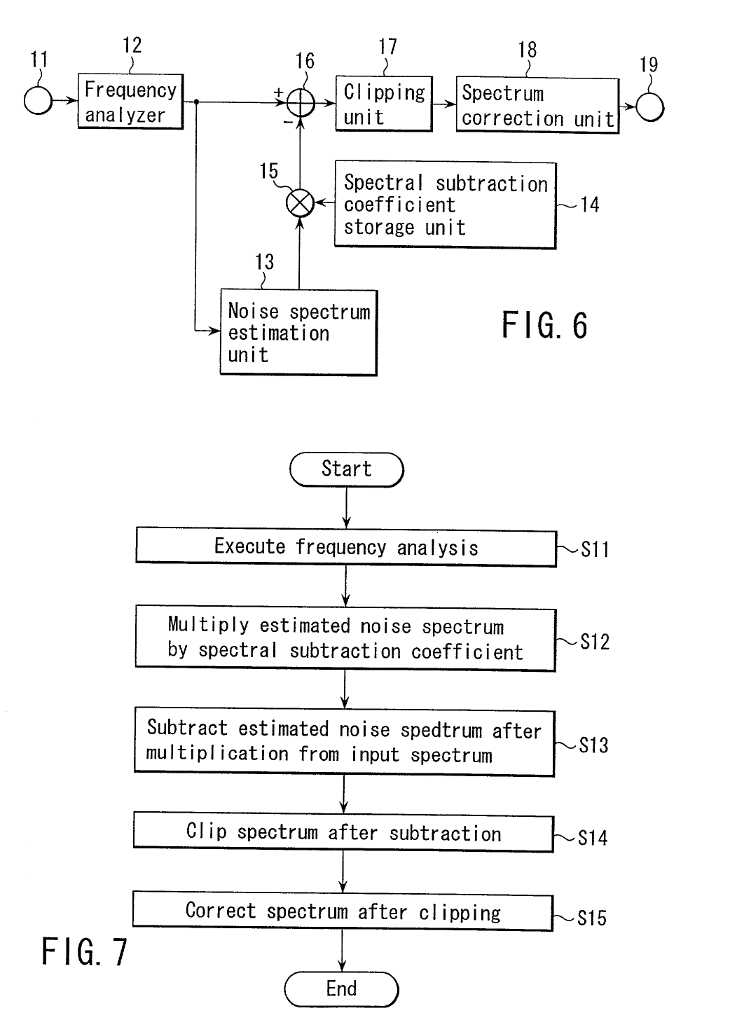

FIG. 6 shows a noise suppression apparatus according to the first embodiment of the present invention. FIG. 7 shows the flow of a noise suppression process in this embodiment. As shown in FIGS. 6 and 7, a speech input terminal 11 receives a speech signal, which is segmented into frames each having a specific frame length, and a frequency analyzer 12 executes frequency analysis of the input speech signal (step S11). The frequency analyzer 12 calculates the spectrum (input spectrum) of the input speech signal as follows.

A speech signal for each frame undergoes windowing using a Hamming window, and then undergoes discrete Fourier transformation (DFT). A complex spectrum obtained as a result of DFT is converted into a power or amplitude spectrum, which is determined to be an input spectrum X(i,m) (where i is the frame number, and m is an index corresponding to the frequency). In the description of this embodiment, an amplitude spectrum is used as a spectrum, but a power spectrum may be used instead. In the following description, a spectrum means an amplitude spectrum unless otherwise specified.

An estimated noise spectrum N(i,m) saved in a noise spectrum estimation unit 13 is multiplied by a spectral subtraction coefficient α stored in a spectral subtraction coefficient storage unit 14 by a multiplier 15 (step S12).

A subtractor 16 subtracts the spectrum output from the multiplier 15 from the input spectrum X(i,m):

Y(i, m)=X(i, m)−α·N(i, m) (1)

(step S13) to generate a spectrum (subtraction spectrum) Y(i,m).

The subtraction spectrum Y(i,m) output from the subtractor 16 is input to a clipping unit 17. If the subtraction spectrum Y(i,m) is smaller than a threshold value γ·X(i,m):

Y(i, m)=γ·X(i, m) if X(i, m)−α·N(i, m)<γ·X(i, m) (2)

where γ is zero or a small constant close to zero (γ=0.01 in this embodiment), it is substituted by γ·X(i,m) to attain clipping, thus obtaining a speech spectrum (step S14). This clipping is a process for avoiding the speech spectrum from assuming a negative value.

A spectrum correction unit 18 corrects the speech spectrum Y(i,m) as a spectrum after clipping (step S15). Y′(i,m) represents a spectrum after correction (corrected spectrum) obtained by correcting a speech spectrum Y(i,m) with frame number i and frequency m. The corrected spectrum Y′(i,m) is output from a speech output terminal 19 as an output speech signal.

The correction method of the speech spectrum Y(i,m) in the spectrum correction unit 18 includes a method of correcting the speech spectrum (speech spectrum elements which form that spectrum) Y(i,m) using neighboring speech spectrum elements in the frequency domain, and a method of correcting it using neighboring speech spectrum elements in the time domain, as will be described below. Note that the speech spectrum Y(i,m) may be corrected using neighboring speech spectrum elements in both the frequency and time domains, although a detailed description of such method will be omitted.

(Method of Correcting Speech Spectrum Using Neighboring Spectrum in Frequency Domain)

The method of correcting a speech spectrum using neighboring speech spectrum elements in the frequency domain will be described first. The corrected spectrum Y′(i,m) is calculated using neighboring speech spectrum elements Y(i,m+k) (k=−K1, −K1+1, . . . , K2) of the speech spectrum (speech spectrum elements which form that spectrum) Y(i,m) in the frequency domain. Note that k corresponds to the number of each channel (frequency band) formed by equally dividing the frequency band on the frequency axis, and K1 and K2 are positive constants.

More specifically, the corrected spectrum Y′(i,m) is calculated by:

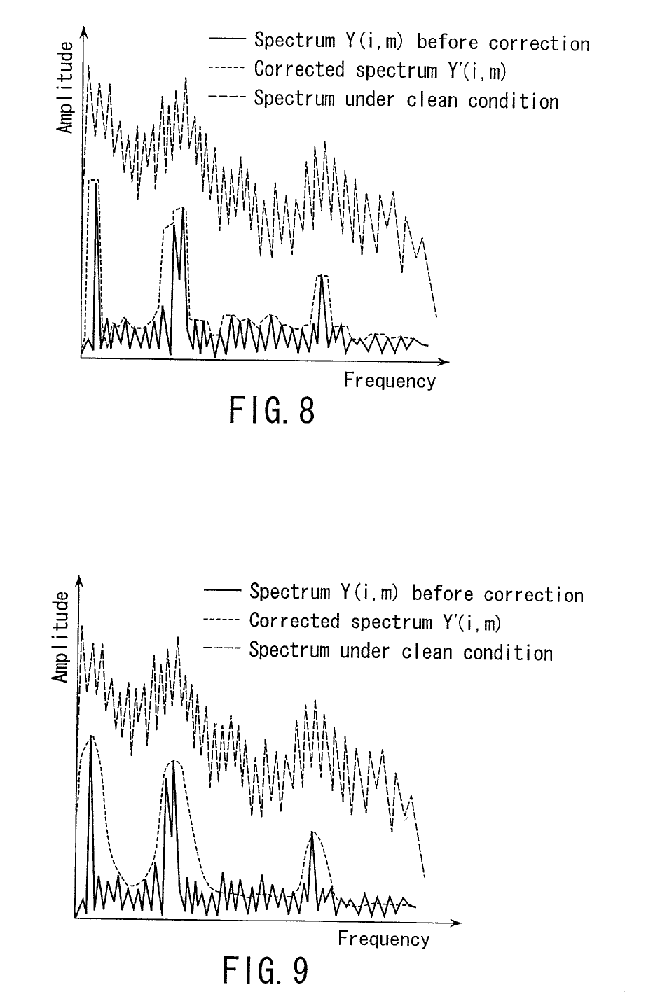

Y′(i, m)=max(Y(i, m+k)) (k=−K1,−K1+1, . . . , K2) (3)

where max( ) is a function that outputs a maximum value. In this method, the speech spectrum (speech spectrum elements which form that spectrum) Y(i,m) is substituted by a maximum value of neighboring spectrum elements Y(i,m+k) to obtain the corrected spectrum Y′(i,m). The effect of this method will be explained below using FIG. 8. In FIG. 8, K1=K2=1.

Referring to FIG. 8, the solid curve represents the speech spectrum Y(i,m) before correction, the dotted curve represents the corrected spectrum Y′(i,m) obtained after correction by the aforementioned method, and the dashed curve represents a speech spectrum under the clean condition free from any superposed noise. As can be understood from FIG. 8, the speech spectrum is smoothed by correction, and becomes closer to an approximate shape of the spectrum under the clean condition. Hence, the aforementioned first problem can be solved.

With this effect, when the noise suppression process according to this embodiment is applied as a pro-process of a speech recognition unit (to be described later), the recognition rate can be improved. In general, since speech recognition is based on the feature amount calculated from information of an approximate shape of the spectrum, the noise suppression process according to this embodiment is very effective.

As a modification of this method, a corrected spectrum Y′(i,m) may be generated using a positive constant β equal to or smaller than 1:

Y′(i, m)=max(β^{|k|}·Y(i, m+k)) (k=−K1,−K1+1, . . . , K2) (4)

In this case, the same effect as in the above method can be obtained.

Also, a method of generating a corrected spectrum Y′(i,m) by convoluting the speech spectrum Y(i,m) using a specific function h(j) may be used. This method is given by:

$${Y}^{′} ( i , m ) = {\sum }_{j = - ( J - 1 ) / 2}^{( J - 1 ) / 2} Y ( i , m - j ) \cdot h ( j + ( J - 1 ) / 2 ) \qquad ( 5 )$$

where J is the number of elements of the function h(j). As the function h(j), a convex function in which the center of h(j) becomes a maximum value, e.g., a function h(j)={0.1, 0.4, 0.7, 1.0, 0.7, 0.4, 0.1} may be appropriately used.

FIG. 9 shows the correction process of the speech spectrum by this method. In FIG. 9, the solid curve represents the speech spectrum Y(i,m) before correction, the dotted curve represents the corrected spectrum Y′(i,m), and the dashed curve represents a speech spectrum under the clean condition free from any superposed noise as in FIG. 8. With this method, as can be seen from FIG. 9, the speech spectrum is smoothed, and becomes close to an approximate shape of the speech spectrum under the clean condition. Hence, the first problem can be solved.

(Method of Correcting Speech Spectrum Using Neighboring Spectrum in Time Domain)

A method of correcting a speech spectrum Y(i,m) using neighboring speech spectrum elements in the time domain will be explained below. The corrected spectrum Y′(i,m) is calculated using neighboring speech spectrum elements Y(i+k,m) (k=−K1, −K1+1, . . . , K2) of the speech spectrum (speech spectrum elements which form that spectrum) Y(i,m) in the time domain. Note that k corresponds to the number of each time band formed by equally dividing time on the time axis, and K1 and K2 are positive constants.

More specifically, the corrected spectrum Y′(i,m) is calculated by:

Y′(i, m)=max(Y(i+k,m)) (k=−K1,−K1+1, . . . , K2) (6)

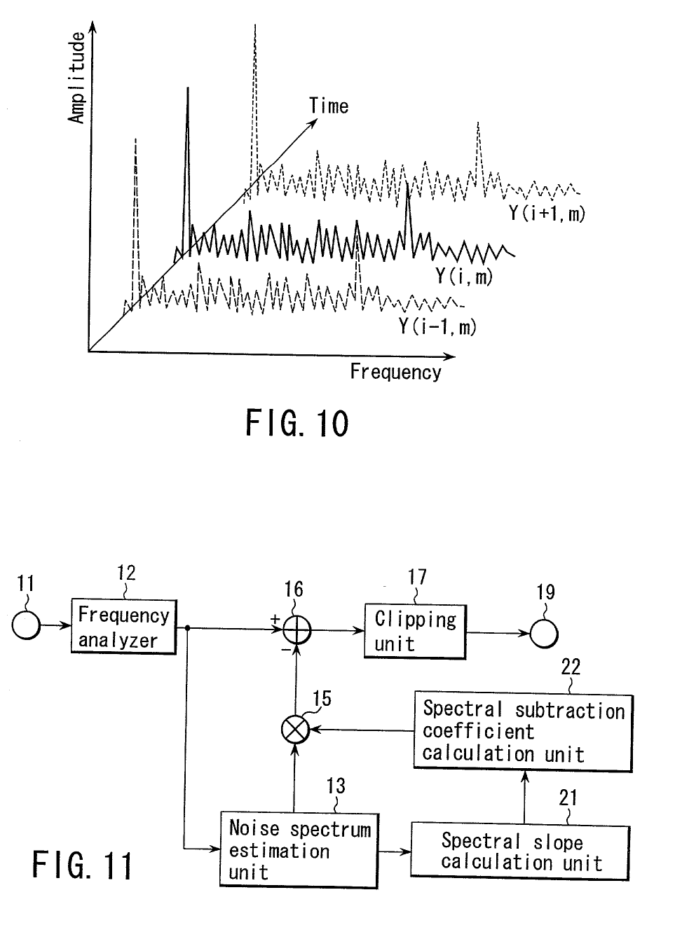

This effect will be explained below using FIG. 10. FIG. 10 shows an example wherein the second formant which should be present in the speech spectrum Y(i,m) disappears due to noise. When correction is made using K1=K2=1, since a spectral peak corresponding to the second formant in Y′(i−1,m) is present, the disappeared spectral peak can be restored by the aforementioned correction. In this way, the aforementioned second problem can be solved.

As a modification of this method, a corrected spectrum Y′(i,m) may be generated using a positive constant β equal to or smaller than 1:

Y′(i, m)=max(β^{|k|}·Y(i+k, m)) (k=−K1,−K1+1, . . . , −K2) (7)

In this case, the same effect as in the above method can be obtained.

Whether or not a spectral peak disappears depends on the phase relationship between the speech signal and noise components. Since the phases of noise components normally change randomly, a spectral peak may disappear at given time, but may appear at another time. That is, as the spectrum is observed for a longer period of time, i.e., as larger K1 and K2 are set, the spectral peak is more likely to be restored. However, if the spectrum is observed for too long a time period, correction may be done using a wrong phoneme. Hence, appropriate K1 and K2 must be set.

Also, a method of generating the corrected spectrum Y′(i,m) by convoluting the speech spectrum Y(i,m) using a specific function h(j) may be used. This method is given by:

$${Y}^{′} ( i , m ) = {\sum }_{j = - ( J - 1 ) / 2}^{( J - 1 ) / 2} Y ( i - j , m ) \cdot h ( j + ( J - 1 ) / 2 ) \qquad ( 8 )$$

where J is the number of elements of the function h(j). As the function h(j), a convex function in which the center of h(j) becomes a maximum value, e.g., a function h(j)={0.1, 0.4, 0.7, 1.0, 0.7, 0.4, 0.1} may be appropriately used.

As another method, a method of correcting using only the current to past spectrum elements without using any future spectrum elements, i.e., setting K2=0, may be used. Since this method uses the current to past spectrum elements, no time delay is generated.

As still another method, a method of correcting the speech spectrum using an AR (Autoregressive) filter may be used. In this case, the corrected spectrum Y′(i,m) is given by:

$${Y}^{′} ( i , m ) = Y ( i , m ) + {\sum }_{j = 1}^{J} {α}_{mr} ( j ) \cdot {Y}^{′} ( i - j , m ) \qquad ( 9 )$$

where αₘᵣ is a filter coefficient, and J is the filter order.

Likewise, a method of correcting the speech spectrum using an MA (Moving Average) filter is also available. In this case, the corrected spectrum Y′(i,m) is given by:

$${Y}^{′} ( i , m ) = Y ( i , m ) + {\sum }_{j = 1}^{J} {α}_{ma} ( j ) \cdot Y ( i - j , m ) \qquad ( 10 )$$

where αₘₐ is a filter coefficient, and J is the filter order. These methods can obtain the same effect, since they can restore the disappeared spectral peak to solve the aforementioned second problem, although different implementation methods are used. Furthermore, the aforementioned correction methods may be combined.

<Second Embodiment>

FIG. 11 shows the arrangement of a noise suppression apparatus according to the second embodiment of the present invention. The same reference numerals in FIG. 11 denote the same parts as in FIG. 6. In this embodiment, a spectral slope calculation unit 21 is added. The spectral slope calculation unit 21 calculates the slope of the estimated noise spectrum obtained by the noise spectrum estimation unit 13. A spectral subtraction coefficient calculation unit 22 calculates a spectral subtraction coefficient α based on this spectral slope, and supplies it to the multiplier 15. Since this embodiment calculates, as the spectral subtraction coefficient α, different values for respective frequencies, each coefficient will be expressed by α(m) hereinafter.

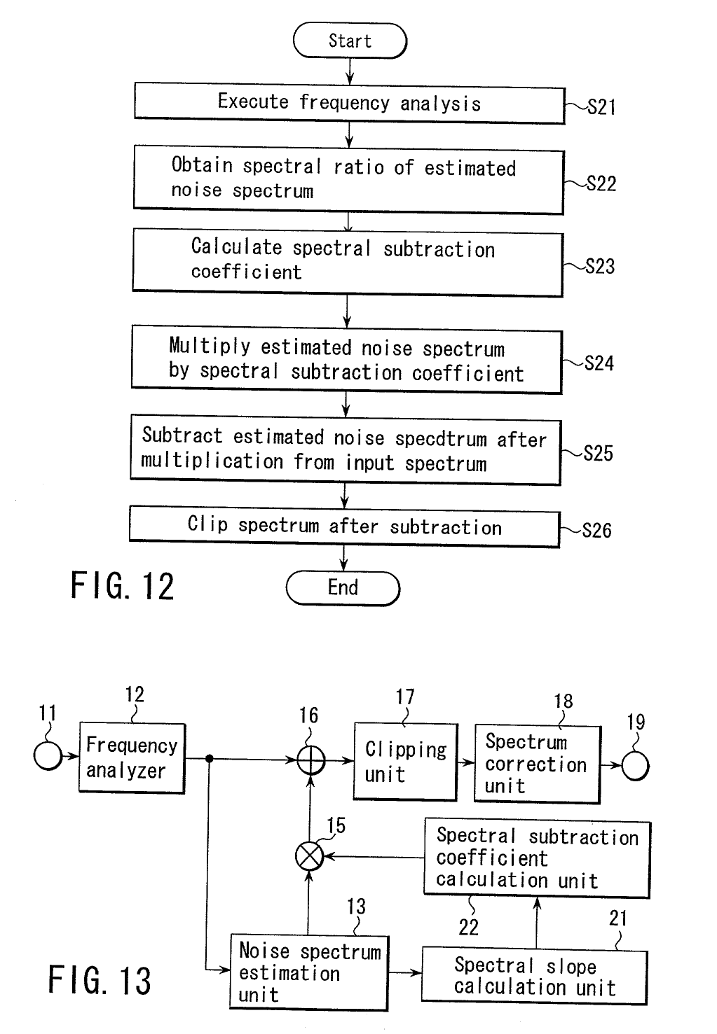

The flow of the noise suppression process in this embodiment will be described below using FIG. 12.

As in the first embodiment, the frequency analyzer 11 executes frequency analysis of an input speech signal (step S21). A spectral ratio between the low- and high-frequency ranges is calculated to calculate the slope of the estimated noise spectrum N(i,m) in the spectral slope calculation unit 21 (step S22). This spectral ratio r is given by:

$$r = \sqrt{\frac{{\sum }_{m ∈ FH} {N}^{2} ( i , m )}{{\sum }_{m ∈ FL} {N}^{2} ( i , m )}} \qquad ( 11 )$$

where FL is a set of indices of frequencies which belong to the low-frequency range, and FH is a set of indices of frequencies which belong to the high-frequency range.

The spectral subtraction coefficient calculation unit 22 calculates a spectral subtraction coefficient α(m) using the spectral ratio r (step S23). In this embodiment, a smaller spectral subtraction coefficient α(m) is set with increasing spectral ratio r, i.e., a larger spectral subtraction coefficient α(m) is set with decreasing spectral ratio r, in terms of the third problem mentioned above. That is, a smaller spectral subtraction coefficient α(m) is set with increasing frequency, i.e., a larger spectral subtraction coefficient α(m) is set with decreasing frequency.

More specifically, the spectral subtraction coefficient α(m) is expressed as a function of the spectral ratio r and frequency index m:

α(m)=max(0.0, min(F(r, m),αc)) (12)

A feature of a function F(r,m) lies in that it becomes a monotone decreasing function with respect to the spectral ratio r, and becomes a monotone decreasing function with respect to the frequency index m. The output of the function F(r,m) is processed to fall within the range from 0.0 to αc (where αc is the maximum spectral subtraction coefficient, which is pre-set like αc=2.0). By calculating the spectral subtraction coefficient α(m) in this way, the influence of the aforementioned third problem can be reduced.

One example of the function F(r,m) is given by:

$$F ( r , m ) = α c \cdot ( 1.0 - r \cdot \frac{m}{M - 1} ) \qquad ( 13 )$$

where M is an index corresponding to the maximum frequency. This equation meets the aforementioned condition.

The multiplier 15 then multiplies the estimated noise spectrum obtained by the noise spectrum estimation unit 13 by the spectral subtraction coefficient α(m) calculated in step S23 (step S24). The subtractor 16 subtracts the estimated noise spectrum multiplied with the spectral subtraction coefficient α(m) from the input spectrum (step S25), and the subtraction spectrum undergoes clipping (step S26), thus obtaining an output speech signal in which noise components have been suppressed.

<Third Embodiment>

FIG. 13 shows the arrangement of a noise suppression apparatus according to the third embodiment of the present invention. This embodiment adopts an arrangement as a combination of the first and second embodiments, i.e., an arrangement in which the spectrum correction unit 18 shown in FIG. 6 as the first embodiment is arranged on the output side of the clipping unit 17 in FIG. 11 as the second embodiment. With this arrangement, this embodiment can obtain an effect as a combination of the effects of both the first and second embodiments.

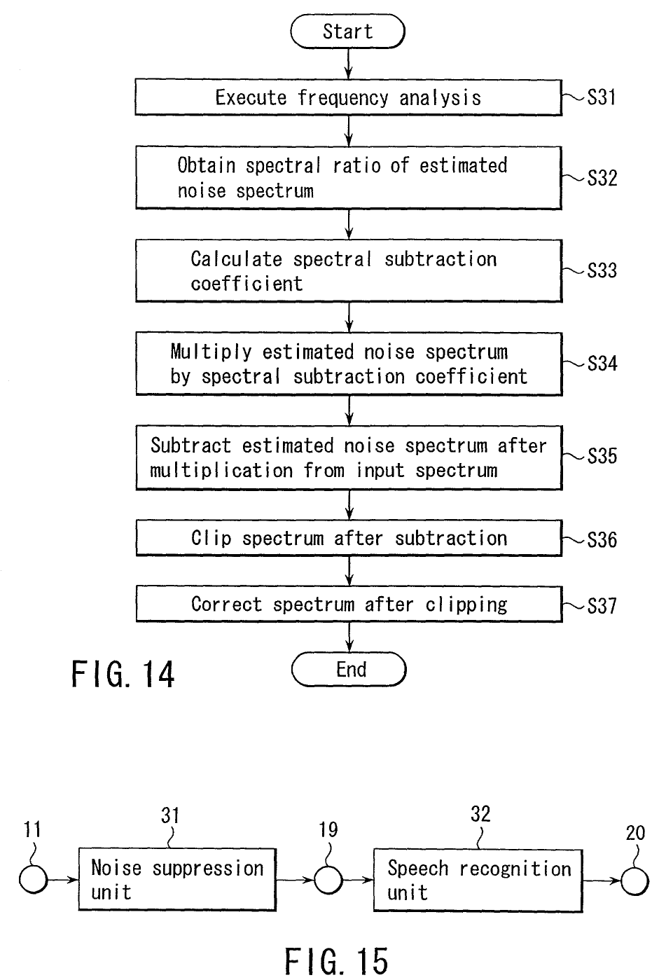

In this embodiment, as shown in FIG. 14 that shows the processing flow, an input speech signal undergoes frequency analysis by a specific frame length to obtain an input spectrum (step S31), and the spectral ratio of an estimated noise spectrum is calculated (step S32). Then, a spectral subtraction coefficient α(m) is calculated (step S33), and the estimated noise spectrum is multiplied by the spectral subtraction coefficient α(m) (step S34). The estimated noise spectrum multiplied with the spectral subtraction coefficient α(m) is subtracted from the input spectrum (step S35), and the spectrum after subtraction undergoes clipping (step S36). Finally, the spectrum after clipping is corrected to obtain a corrected spectrum (step S37), thus obtaining an output speech signal.

<Fourth Embodiment>

FIG. 15 shows an example in which the present invention is applied to a speech recognition apparatus as the fourth embodiment of the present invention. Referring to FIG. 15, a speech signal input from a speech input terminal 11 is input to a noise suppression unit 31, and noise components are suppressed from the speech signal. An output speech signal output from the noise suppression unit 31 to a speech output terminal 19 is input to a speech recognition unit 32. The speech recognition unit 32 executes a speech recognition process of the speech signal output from the noise suppression unit 31, and outputs a recognition result to an output terminal 20.

Note that the noise suppression unit 31 includes the noise suppression apparatus described in one of the first to third embodiments. For example, if the noise suppression unit 31 includes the noise suppression apparatus described in the third embodiment, the spectrum correction unit 18 in FIG. 13 outputs the corrected spectrum Y′(i,m), which is input as a speech signal from the speech output terminal 19 to the speech recognition unit 32. The speech recognition unit 32 calculates the feature amount of the speech signal based on the corrected spectrum Y′(i,m), obtains a candidate with highest similarity to this feature amount among those contained in a specific dictionary as a recognition result, and outputs that result to the output terminal 20.

As described above, according to this embodiment, when the noise suppression apparatus described in any one of the first to third embodiments is used in the pre-process of speech recognition, a high recognition rate can be realized.

The aforementioned noise suppression process of a speech signal according to the present invention can be implemented by software using a computer such as a personal computer, workstation, or the like. Therefore, according to the present invention, a computer-readable recording medium that stores the following program or a program itself can be provided.

(1) A computer-executable program code which suppresses noise components contained in an input speech signal when executed by a computer, or a computer-readable recording medium that stores the same program code, in which the program code includes obtaining an input spectrum by frequency-analyzing the input speech signal by a specific frame length, obtaining an estimated noise spectrum by estimating a spectrum of the noise components, multiplying the estimated noise spectrum by a specific spectral subtraction coefficient, obtaining a subtraction spectrum by subtracting the estimated noise spectrum multiplied with the spectral subtraction coefficient from the input spectrum, obtaining a speech spectrum by clipping the subtraction spectrum, and correcting the speech spectrum by smoothing in at least one of frequency and time domains so as to obtain an output speech signal in which noise components have been suppressed.

(2) A computer-executable program code which suppresses noise components contained in an input speech signal when executed by a computer, or a computer-readable recording medium that stores the same program code, in which the program code includes obtaining an input spectrum by frequency-analyzing the input speech signal by a specific frame length, obtaining an estimated noise spectrum by estimating a spectrum of the noise components, obtaining the spectral slope of the estimated noise spectrum, multiplying the estimated noise spectrum by a spectral subtraction coefficient determined by the spectral slope, obtaining a subtraction spectrum by subtracting the estimated noise spectrum multiplied with the spectral subtraction coefficient from the input spectrum, and obtaining a speech spectrum by clipping the subtraction spectrum so as to obtain an output speech signal in which noise components have been suppressed.

(3) A computer-executable program code which suppresses noise components contained in an input speech signal when executed by a computer, or a computer-readable recording medium that stores the same program code, in which the program code includes obtaining an input spectrum by frequency-analyzing the input speech signal by a specific frame length, obtaining an estimated noise spectrum by estimating a spectrum of the noise components, obtaining the spectral slope of the estimated noise spectrum, multiplying the estimated noise spectrum by a spectral subtraction coefficient determined by the spectral slope, obtaining a subtraction spectrum by subtracting the estimated noise spectrum multiplied with the spectral subtraction coefficient from the input spectrum, obtaining a speech spectrum by clipping the subtraction spectrum, and correcting the speech spectrum by smoothing in at least one of frequency and time domains so as to obtain an output speech signal in which noise components have been suppressed.

As described above, according to the present invention, since the spectrum obtained by subtracting the estimated noise spectrum from the input spectrum undergoes clipping, and is then corrected by smoothing on the frequency or time axis, the spectrum of an output speech signal can become close to an approximate shape of an original speech spectrum while suppressing noise components. Since the spectral subtraction coefficient is calculated based on the shape of the estimated noise spectrum, spectral subtraction can be done more accurately, and a satisfactory noise suppression effect can be obtained. Furthermore, when the noise suppression process of the present invention is used as a pre-process of a speech recognition process, a high recognition rate can be achieved in a noise environment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of suppressing noise components contained in an input speech signal, comprising:
obtaining an input spectrum by executing frequency analysis of the input speech signal by a specific frame length;
obtaining an estimated noise spectrum by estimating a spectrum of the noise components;
multiplying the estimated noise spectrum by a specific spectral subtraction coefficient;
obtaining a subtraction spectrum by subtracting the estimated noise spectrum multiplied with the spectral subtraction coefficient from the input spectrum;
obtaining a speech spectrum by clipping the subtraction spectrum; and
correcting the speech spectrum by smoothing in at least one of frequency and time domains.

2. The method according to claim 1, wherein the correcting the spectrum includes smoothing speech spectrum elements which form the speech spectrum, using neighboring speech spectrum elements in at least one of the frequency and time domains.

3. The method according to claim 2, wherein the correcting the spectrum includes substituting the speech spectrum elements by a maximum value of the neighboring speech spectrum elements.

4. The method according to claim 1, wherein the correcting the spectrum includes convoluting the speech spectrum using a specific function in at least one of the frequency and time domains.

5. A method of suppressing noise components contained in an input speech signal, comprising:
obtaining an input spectrum by executing frequency analysis of the input speech signal by a specific frame length;
obtaining an estimated noise spectrum by estimating a spectrum of the noise components;
obtaining a spectral slope of the estimated noise spectrum;
multiplying the estimated noise spectrum by a spectral subtraction coefficient determined by the spectral slope;
obtaining a subtraction spectrum by subtracting the estimated noise spectrum multiplied with the spectral subtraction coefficient from the input spectrum; and
obtaining a speech spectrum by clipping the subtraction spectrum.

6. The method according to claim 5, wherein a smaller spectral subtraction coefficient is set with increasing spectral slope.

7. The method according to claim 5, further comprising correcting the speech spectrum by smoothing in at least one of frequency and time domains.

8. A noise suppression apparatus for suppressing noise components contained in an input speech signal, comprising:
a frequency analyzer configured to obtain an input spectrum by executing frequency analysis of the input speech signal by a specific frame length;
a noise spectrum estimation unit configured to obtain an estimated noise spectrum by estimating a spectrum of the noise components;
a multiplier configured to multiply the estimated noise spectrum by a specific spectral subtraction coefficient;
a subtractor configured to obtain a subtraction spectrum by subtracting the estimated noise spectrum multiplied with the spectral subtraction coefficient from the input spectrum;
a clipping unit configured to obtain a speech spectrum by clipping the subtraction spectrum; and
a spectrum correction unit configured to correct the speech spectrum by smoothing in at least one of frequency and time domains.

9. The apparatus according to claim 8, wherein said spectrum correction unit smoothes speech spectrum elements which form the speech spectrum, using neighboring speech spectrum elements in at least one of the frequency and time domains.

10. The apparatus according to claim 9, wherein said spectrum correction unit substitutes the speech spectrum elements by a maximum value of the neighboring speech spectrum elements.

11. The apparatus according to claim 8, wherein said spectrum correction unit convolutes the speech spectrum using a specific function in at least one of the frequency and time domains.

12. A noise suppression apparatus for suppressing noise components contained in an input speech signal, comprising:
a frequency analyzer configured to obtain an input spectrum by executing frequency analysis of the input speech signal by a specific frame length;
a noise spectrum estimation unit configured to obtain an estimated noise spectrum by estimating a spectrum of the noise components;
a spectral slope calculation unit configured to obtain a spectral slope of the estimated noise spectrum;
a multiplier configured to multiply the estimated noise spectrum by a spectral subtraction coefficient determined by the spectral slope;
a subtractor configured to obtain a subtraction spectrum by subtracting the estimated noise spectrum multiplied with the spectral subtraction coefficient from the input spectrum; and
a clipping unit configured to obtain a speech spectrum by clipping the subtraction spectrum.

13. The apparatus according to claim 12, wherein a smaller spectral subtraction coefficient is set with increasing spectral slope.

14. The apparatus according to claim 12, further comprising a spectrum correction unit configured to correct the speech spectrum by smoothing in at least one of frequency and time domains.
